(19) United States
(12) Patent Application Publication
(10) Pub. No.: US 2026/0212143 A1
(43) Pub. Date: Jul. 23, 2026

(54) ANTENNA SYSTEM AND ELECTRONIC PAYMENT TERMINAL COMPRISING SUCH AN ANTENNA SYSTEM

(71) Applicant: BANKS AND ACQUIRERS INTERNATIONAL HOLDING, SURESNES (FR)

(72) Inventors: Florence PANETTA, SURESNES (FR); Mampionona RAKOTOBE, SURESNES (FR); Abdenour AINOUCHE, SURESNES (FR); Bruno XAVIER, SURESNES (FR); Ferhaj CHOWDHARY, SURESNES (FR); Stéphane ESTORGES, SURESNES (FR); Jean-Eric LEMAIRE, SURESNES (FR); Pierre MOREL, SURESNES (FR)

(21) Appl. No.: 19/141,102

(22) PCT Filed: Dec. 20, 2023
(86) PCT No.: PCT/EP2023/086823

§ 371 Date: Jun. 19, 2025

(30) Foreign Application Priority Data
Dec. 21, 2022 (FR) FR2214082

(51) Int. Cl. G06K 7/10; G07F 7/08; H01R 12/57; H01R 13/24

(52) U.S. Cl. CPC G06K 7/10316; G07F 7/0893; H01R 12/57; H01R 13/2435

(57) ABSTRACT

An antenna system including a radio communication antenna having a first end and a second end between which at least one turn extends, an electronic card configured to receive and process data from the radio communication antenna, and a plurality of electrical connection members electrically connecting the radio communication antenna and the electronic card by contact. The electronic card includes a plurality of gold contact tracks, and each electrical connection member being composed of a foot fixed to the radio communication antenna, a contact head coated with gold and in contact with one of the contact tracks, and a body connecting the foot to the contact head. An electronic payment terminal including such an antenna system.

### TECHNICAL FIELD

The invention relates to the field of electronic terminals having a contactless communication transaction function. More particularly, the invention relates to an antenna system configured for contactless communication with a contactless transaction device, such contactless communication also being referred to as “contactless” or CLESS. More particularly, the invention applies to the field of electronic payment terminals that have a contactless payment function, i.e. configured to communicate contactlessly with a contactless payment device.

### BACKGROUND

An antenna system configured for contactless communication with a contactless transaction device is already known in the state of the art. Such an antenna system typically comprises a radio communication antenna and an electronic card configured to receive and process data from the contactless transaction device via the radio communication antenna.

In order to electrically connect the radio communication antenna and the electronic card, it is known to arrange a flexible printed circuit between the radio communication antenna and the electronic card, or even to make the radio communication antenna in the form of a flexible printed circuit. Such a flexible printed circuit is connected to the electronic card by a connector mounted on the electronic card. However, such a flexible printed circuit is expensive.

An alternative solution is to mount a connector on the electronic board, into which the ends of an electrical wire are snapped, between which the electrical wire is wound in the form of at least one turn, thus forming the wireless communication antenna. The ends of the wire are twisted into a helix near the connector to make it easier to snap them into the connector when the antenna system is assembled. However, such a solution requires a great deal of assembly time, and does not offer sufficient reliability, for example sufficient repeatability with regard to the communication performance of the radio communication antenna, particularly as the ends of the wire are helically twisted and can modify the winding of the turn, for example due to repeated vibrations or shocks.

### SUMMARY

Thus, one of the aims of the invention is to provide a reliable antenna system with reduced manufacturing costs.

To this end, the invention relates to an antenna system configured for contactless communication with a contactless transaction device, the antenna system comprising:
a radio communication antenna preferably having a first end and a second end between which at least one turn extends,
an electronic card configured to receive and process data from the contactless transaction device via the radio communication antenna,
a plurality of electrical connection members electrically connecting by contact the radio communication antenna and the electronic card,
an antenna system in which
the electronic card comprises a plurality of contact tracks made of gold, and each electrical connection member is composed of a foot fixed to the radio communication antenna, a contact head coated with gold and in contact with one of the contact tracks, and a body connecting the foot to the contact head.

In this way, the radio communication antenna and the electronic card are electrically connected in a reliable manner, by means of a gold-gold contact. The gold-gold contact present between the electronic card and the electrical connection member is also of low manufacturing cost, since only the contact head is coated with gold, the production of gold contact tracks on an electronic card also being inexpensive, for example by a gold plating process, in particular compared with the production of gold contact zones on a radio communication antenna. As a result, the resulting antenna system is both reliable and low-cost to manufacture.

Other optional features of the antenna system, taken alone or in combination, are as follows:
The foot of a first electrical connection member is attached to the first end, and the foot of a second electrical connection member is attached to the second end. This optimises the performance of the radio communication antenna.
The body forms a spring and is configured to press the contact head onto the contact track. In this way, contact is maintained in a simple manner.
The radio communication antenna has a resonance frequency of between 12 MHz and 20 MHz, preferably 13.56 MHz.
The radio communication antenna is metallic. In this way, the radio communication antenna is obtained simply and economically.
The foot of each electrical connection member is welded to the radio communication antenna. This means that each electrical connection member can be attached to the radio communication antenna simply and reliably.
Each electrical connection member is welded to the radio communication antenna by laser welding. This makes welding simple and cost-effective.
Each electrical connection member is welded to the radio communication antenna by spot welding. This makes welding particularly simple.
The antenna system comprises three electrical connection members connecting the radio communication antenna and the electronic card by contact, the electronic card comprises three gold contact tracks, the foot of a first electrical connection member being fixed to the first end, the foot of a second electrical connection member being fixed to the second end, and the foot of a third electrical connection member being fixed at equal travel distance on the radio communication antenna between the first end and the second end. Thus, the addition of a third contact between the electronic card and the radio communication antenna makes it possible to fulfil a function additional to that of radio communication, such as protecting the electronic card against electrostatic discharges.
The contact track in contact with the contact head of the third electrical connection member is connected to the ground of the electronic card. This third contact is therefore connected to ground and therefore enables electrostatic discharges from the radio communication antenna to be discharged easily to the electronic card, without damaging any electronic component of the electronic card and without modifying the radio communication characteristics.
The communication antenna comprises at least two turns.
The turns are parallel.
The median spacing between each turn is between 0.5 and 1 mm, preferably equal to 0.7 mm.
The communication antenna comprises two turns, the foot of the third electrical connection member being fixed between the first turn and the second turn. This arrangement is spatially advantageous, as the three electrical connection members are close to each other.
The radio communication antenna is formed by a stamped metal strip. Such a communication antenna is thus obtained economically and reliably. Such a radio communication antenna is in particular more economical than an antenna formed by a flexible printed circuit, and is obtained with improved repeatability, in particular in that it exhibits fewer variations during manufacture than a communication antenna formed by a metal wire.
The metal strip has a thickness of between 0.1 and 0.5 mm, preferably between 0.2 and 0.4 mm, more preferably equal to 0.2 mm. Such a thickness offers a good compromise between cost and performance. In particular, a thickness equal to 0.2 mm offers an excellent compromise between cost and performance, while remaining easy to handle during manufacture without undergoing deformation that hinders its assembly in the antenna system.
The radio communication antenna is made of stainless steel, copper or brass, preferably brass. The use of stainless steel, copper or brass ensures good performance of the radio communication antenna. In particular, the use of brass offers a good compromise between cost and performance. Furthermore, brass is easy to solder with stainless steel.
Each electrical connection member is formed by a folded blade forming the foot, the body and the contact head, the blade preferably being made of stainless steel. In this way, each electrical connection member is made particularly simply and economically.
The electrical connection components are identical. Manufacturing costs are therefore reduced by the use of a single type of electrical connection element.
The radio communication antenna is mounted on a support.
The support comprises fixing means for the radio communication antenna.
The support is made of plastic. The support is therefore simple to make.
The fixing means comprise snaps. The fixing means are therefore simple and reliable.
Each end of the radio communication antenna is fixed to the support by a snap. In this way, the communication antenna is fixed in a particularly simple and reliable manner.
The support includes positioning means, which are configured to position the electronic card on the support.
The positioning means comprise pins passing through the electronic card. The positioning means are therefore simple to implement.
The contactless transaction device is a contactless payment device, for example a contactless payment card.
The radio communication antenna is configured for near-field communication.

The invention also relates to an electronic payment terminal comprising an antenna system as previously described, configured for contactless communication with a contactless payment device.

### BRIEF DESCRIPTION OF THE FIGURES

The invention will be better understood on reading the following description, which is given by way of example only and with reference to the attached drawings in which:

FIG. 1 is a schematic perspective view of an electronic payment terminal comprising an antenna system according to one embodiment, and of a contactless payment device in the form of a contactless payment card;

FIG. 2 is a schematic perspective view from below of an antenna system included in the payment terminal shown in FIG. 1;

FIG. 3 is a schematic perspective view of part of the antenna system shown in FIG. 2;

FIG. 4 is a schematic perspective view of a detail of the part of the antenna system shown in FIG. 3;

FIG. 5 is a schematic top view of part of the antenna system shown in FIG. 2.

### DETAILED DESCRIPTION

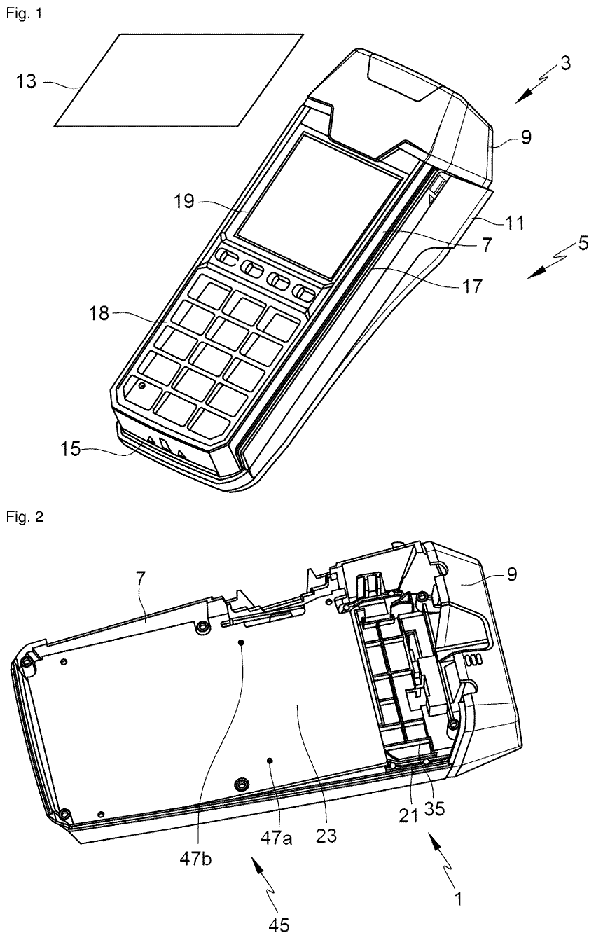

With reference to FIGS. 1 to 5, an embodiment of an antenna system 1 according to the invention, integrated into an electronic payment terminal 3 according to the invention, is described below. In FIGS. 1 to 5, elements similar to those in the previous Figures are designated by identical references.

The electronic payment terminal 3 shown in FIG. 1 comprises a housing 5 consisting of an upper part 7, a rear part 9 and a lower part 11. Housing 5 is made of plastic, for example. The electronic payment terminal 3 therefore includes the antenna system 1 inside the housing 5. The antenna system 1 is configured for contactless communication with a contactless transaction device, such as a contactless payment device, for example a contactless payment card 13 as shown in FIG. 1. In the example shown, the electronic payment terminal 3 also includes a smart card reader 15, which is conventional, as well as a magnetic card reader 17, which is also conventional. The electronic payment terminal 3 is also equipped with an input keyboard 18 comprising keys, not shown, and a display screen 19.

The antenna system 1, shown at least in part in FIGS. 2 to 5, comprises a radio communication antenna 21, an electronic card 23 and a plurality of electrical connection members 25a-25c electrically connecting the radio communication antenna 21 and the electronic card 23 by contact.

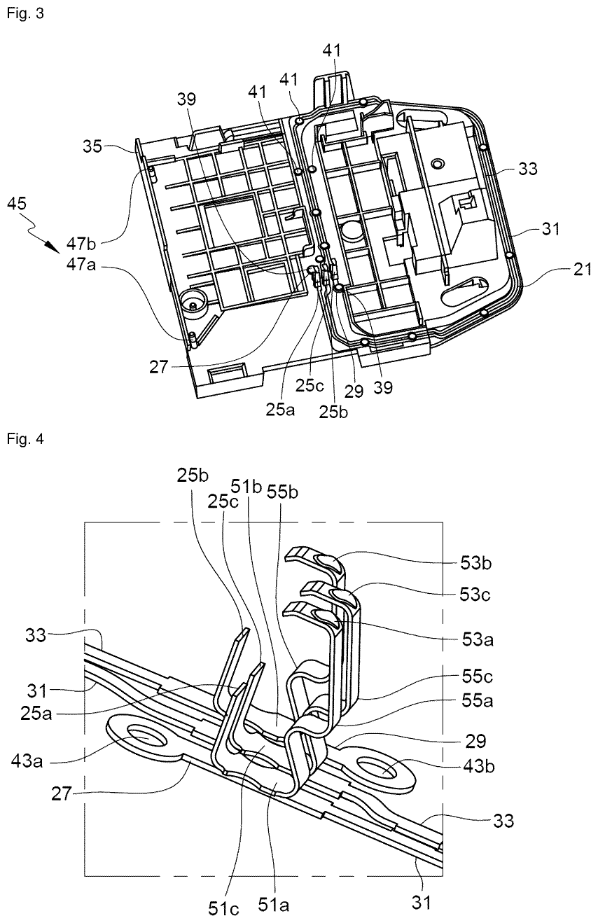

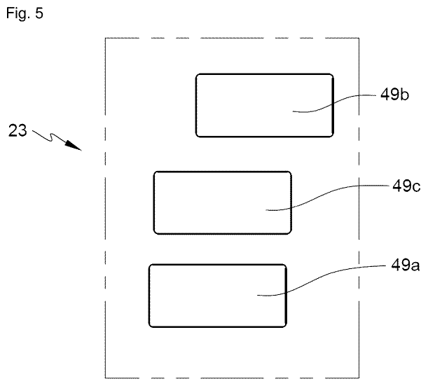

The radio communication antenna 21, as shown in FIG. 2, FIG. 3 and partially shown in FIG. 4, comprises a first end 27 and a second end 29. At least one turn 31, 33, preferably at least two turns 31, 33, extend between the first end 27 and the second end 29. In the example shown, the radio communication antenna 21 comprises two turns 31, 33, the turns 31, 33 being parallel. Furthermore, the median spacing between each turn 31, 33 is between 0.5 and 1 mm, preferably equal to 0.7 mm. The radio communication antenna 21 has a resonance frequency of between 12 MHz and 20 MHz, preferably 13.56 MHz. In this example, the radio communication antenna 21 is metallic. More specifically, the radio communication antenna 21 is formed by a stamped metal strip, the metal strip having a thickness of between 0.1 and 0.5 mm, preferably between 0.2 and 0.4 mm, more preferably equal to 0.2 mm. For example, the radio communication antenna 21 is made of stainless steel, copper or brass, preferably brass. In this example, the radio communication antenna 21 is configured for near-field communication, also known by the acronym NFC.

The radio communication antenna 21 is arranged on a support 35, as shown in FIG. 2 and shown in detail in FIG. 3. The support 35 is made of plastic and comprises means 37 for fixing the radio communication antenna 21. For example, the support 35 is held by the upper part 7 and the rear part 9 of the housing 5. In the example shown in particular in FIG. 3, the fixing means 37 comprise snaps 39, 41, each end 27, 29 of the radio communication antenna 21 being fixed to the support 35 by a snap 39. As can be seen in FIG. 4, each snap 39 is made on an end hole 43a, 43b of the radio communication antenna 21. In addition, other snaps 41 are made in places between the two turns 31, 33, and in places against one of the two turns 31, 33. The snaps 39, 41, for example, are previously formed by pins on the support 35, which enable the radio communication antenna 21 to be positioned on the support 35, and are then deformed by heating and local support to form the snaps 39, 41. The support 35 also includes positioning means 45, which are configured to position the electronic card 23 on the support 35, in the position shown in FIG. 2. In the example shown, the positioning means 45 comprise pins 47a, 47b, in this example two pins 47a, 47b, passing through the electronic card 23. The electronic card is thus arranged and positioned on the support 35, because it rests on the support 35, and is held against the support 35 by the lower part 11 of the housing 5.

The electronic card 23 is configured to receive and process data from the contactless transaction device via the radio communication antenna 21. The electronic card 23 comprises a plurality of gold contact tracks 49a-49c. In the example shown, the electronic card 23 comprises three gold contact tracks 49a-49c, which are shown in FIG. 5, on the top face of the electronic card 23.

In the example shown, the antenna system 1 comprises three electrical connection members 25a-25c, which are shown in detail in FIG. 4. Each electrical connection member 25a-25c is composed of a foot 51a-51c fixed to the radio communication antenna 21, a contact head 53a-53c coated in gold and in contact with one of the contact tracks 49a-49c of the electronic card 23, and a body 55a-55c connecting the foot 51a-51c to the contact head 53a-53c. For example, the gold coating is produced by gold plating on the contact head 53a-53c. In this example, the electrical connection members 25a-25c are identical. The body 55a-55c forms a spring and is configured to press the contact head 53a-53c against the contact track 49a-49c of the electronic card 23. For example, as shown in particular in FIG. 4, each electrical connection member 25a-25c is formed by a folded blade forming the foot 51a-51c, the body 55a-55c and the contact head 53a-53c, the blade preferably being made of stainless steel. In order to form a spring in a simple manner, the body 55a-55c has, for example, an S shape.

In this example, the foot 51a of a first electrical connection member 25a is fixed to the first end 27, and the foot 51b of a second electrical connection member 25b is fixed to the second end 29. Furthermore, the foot 51c of a third electrical connection member 25c is fixed between the first turn 31 and the second turn 33, for example at equal travel distance on the radio communication antenna 21 between the first end 27 and the second end 29. In other words, by virtually deforming the radio communication antenna 21 in the form of a linear segment, the third electrical connection member 25c is fixed in the middle of the radio communication antenna 21, at equal distance between the first end 27 and the second end 29. More precisely, the foot 51a-51c of each electrical connection member 25a-25c is welded to the radio communication antenna 21. For example, each electrical connection member 25a-25c is welded to the radio communication antenna 21 by spot welding or laser welding.

The contact track 49a in contact with the contact head 53a of the first electrical connection member 25a and the contact track 49b in contact with the contact head 53b of the second electrical connection member 25b enable the electronic card 23 to receive and process data from the contactless transaction device via the radio communication antenna 21. In addition, the contact track 49c in contact with the contact head 53c of the third electrical connection member 25c is connected to the ground of the electronic card 23.

The invention is not limited to the embodiments shown and other embodiments will be clear to the person skilled in the art.

### LIST OF REFERENCES

1: antenna system
3: electronic payment terminal
5: housing
7: upper part of housing 5
9: rear of housing 5
11: bottom of housing 5
13: contactless payment card
15: smart card reader
17: magnetic card reader
18: keyboard
19: display screen
21: radio communication antenna
23: electronic card
25a, 25b, 25c: electrical connection member
27: first end
29: second end
31, 33: turn
35: support
37: fixing means
39, 41: snap
43a, 43b: end hole
45: positioning means
47a, 47b: pin
49a, 49b, 49c: contact track
51a, 51b, 51c: foot
53a, 53b, 53c: contact head
55a, 55b, 55c: body

1. An antenna system configured for contactless communication with a contactless transaction device, the antenna system comprising:
a radio communication antenna having a first end and a second end between which at least one turn extends,
an electronic card configured to receive and process data from the contactless transaction device via the radio communication antenna, and
a plurality of electrical connection members electrically connecting by contact the radio communication antenna and the electronic card
wherein the electronic card comprises a plurality of contact tracks made of gold, and
wherein each electrical connection member is composed of a foot fixed to the radio communication antenna, a contact head coated with gold and in contact with one of the contact tracks, and a body connecting the foot to the contact head.

2. The antenna system according to claim 1, in which the foot of each electrical connection member is welded to the radio communication antenna.

3. The antenna system according to claim 1,
wherein the plurality of electrical connection members comprises three electrical connection members connecting the radio communication antenna and the electronic card by contact,
wherein the electronic card comprises three of the contact tracks made of gold, and
wherein the foot of a first electrical connection member being fixed to the first end, the foot of a second electrical connection member being fixed to the second end, and the foot of a third electrical connection member being fixed at equal travel distance on the radio communication antenna between the first end and the second end.

4. The antenna system according to claim 3, in which the contact track in contact with the contact head of the third electrical connection member is connected to a ground of the electronic card.

5. The antenna system according to claim 1, wherein the communication antenna comprises at least two turns.

6. The antenna system according to claim 1, wherein the radio communication antenna is formed by a stamped metal strip.

7. The antenna system according to claim 1, wherein the radio communication antenna is made of stainless steel, copper or brass.

8. The antenna system according to claim 1, wherein each electrical connection member is formed by a folded blade forming the foot, the body and the contact head.

9. The antenna system according to claim 1, wherein the radio communication antenna has a resonance frequency of between 12 MHz and 20 MHz.

10. An electronic payment terminal comprising the antenna system according to claim 1, configured for contactless communication with a contactless payment device.

11. The antenna system according to claim 7, wherein the radio communication antenna is made of brass.

12. The antenna system according to claim 8, wherein the folded blade is made of stainless steel.

13. The antenna system according to claim 9, wherein the resonance frequency is equal to 13.56 MHz.
